(19) United States
(12) Patent Application Publication
(10) Pub. No.: US 2026/0127913 A1
(43) Pub. Date: May 7, 2026

(54) FACIAL RECOGNITION BY AN ELECTRONIC DEVICE IN LOW LIGHT CONDITIONS

(71) Applicant: MOTOROLA MOBILITY LLC, WILMINGTON, DE (US)

(72) Inventors: RANJEET GUPTA, Aurora, IL (US); RAHUL BHARAT DESAI, Hoffman Estates, IL (US)

(21) Appl. No.: 18/939,431

(22) Filed: Nov. 6, 2024

(51) Int. Cl. G06V 40/16; G06F 21/32; G06T 7/90; G06V 10/25; G06V 10/60

(52) U.S. Cl. CPC G06V 40/172; G06F 21/32; G06T 7/90; G06V 10/25; G06V 10/60; G06T 2207/30201

(57) ABSTRACT

An electronic device, a method and a computer program product for controlling image capturing via a first camera to capture images for use in a facial recognition process. The method includes capturing, via a first camera, a first image. The method includes determining if the first image contains a face. In response to determining the first image contains the face, the method includes identifying a skin tone frequency associated with the face. The method includes determining if the skin tone frequency is less than a skin tone frequency threshold. In response to determining the skin tone frequency is less than the skin tone frequency threshold, the method includes decreasing a first shutter speed of the first camera to a second shutter speed. The method includes capturing a second image, via the first camera using the second shutter speed. The method includes performing facial recognition based authentication using the second image.

### BACKGROUND

### 1. Technical Field

The present disclosure generally relates to electronic devices and in particular to facial recognition performed by an electronic device.

### 2. Description of the Related Art

Electronic devices, such as mobile phones, tablets, and laptops, are widely used for video, voice, and text communication and for data transmission. Facial recognition is a technology capable of matching a human face from a captured image against a known image or a database of faces. Facial recognition is used to authenticate and/or validate the identity of a user. Facial recognition can be used by an authenticated user to unlock an electronic device from a locked state. Unfortunately, facial recognition can have difficulty functioning in low light/dark conditions.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices within a connected device ecosystem, according to one or more embodiments;

FIG. 2 is a block diagram of example contents of the memory subsystem of the example electronic device of FIG. 1A configured to complete the various processes described herein, according to one or more embodiments;

FIG. 3 is an example illustration of a user holding the electronic device of FIG. 1 (1A-1B) such that the user's face is detectable within a field of view of the camera of the electronic device, according to one or more embodiments;

FIG. 4A is an example illustration of a display of an electronic device presenting a captured facial image of a user having a dark skin tone in a low light condition., according to one or more embodiments;

FIG. 4B is an example illustration of a display of an electronic device presenting a captured facial image of a user having a dark skin tone in a low light condition after a shutter speed of the camera has been decreased, according to one or more embodiments;

FIGS. 5A-5B depict a flowchart of a method by which an electronic device modifies a shutter speed of a camera based on a detected skin tone frequency of the face of a user, according to one or more embodiments; and

FIGS. 6A-6B depict a flowchart of a method by which an electronic device modifies a shutter speed of a camera based on a measured light intensity value of a region of interest, according to one or more embodiments.

### DETAILED DESCRIPTION

According to one or more aspects of the disclosure, the illustrative embodiments provide an electronic device, a method, and a computer program product for controlling image capturing via a first camera to capture images for use in a facial recognition process. Specifically, the disclosure provides techniques for controlling image capture of facial images, based on skin tone frequency, for use in a facial recognition process.

Completing facial recognition by an electronic device can have difficulty functioning in low light/dark conditions. In a low light/dark environment, facial recognition does not function properly. An electronic device can have difficulty imaging a face in low light conditions and recognizing an individual such as an authorized user of the electronic device. Additionally, facial recognition can often have difficulty functioning with individuals with dark skin tones. Thus, individuals with dark skin tones can experience a higher level of false rejections during a facial recognition process. The embodiments disclosed herein addresses and overcome the aforementioned issues/problems/limitations by controlling image capturing to capture images for use in a facial recognition process. The embodiments disclosed herein enable an electronic device to identify a skin tone frequency of a facial image. The embodiments then enable the electronic device to determine when a skin tone frequency of the facial image is inadequate to accurately complete a facial recognition process and to decrease a shutter speed of a camera to capture a subsequent facial image with sufficient brightness to accurately complete the facial recognition process.

In a first embodiment, an electronic device includes a first camera and a memory having stored thereon a camera control module for controlling image capturing via the first camera. The electronic device includes at least one processor that is communicatively coupled to each of the first camera and the memory, and which executes program code of the camera control module. The at least one processor is configured to cause the electronic device to capture, via the first camera, a first image and determine if the first image contains a face. In response to determining the first image contains the face, the at least one processor identifies a skin tone frequency associated with the face based on the first image. The at least one processor determines if the skin tone frequency is less than a skin tone frequency threshold. In response to determining the skin tone frequency is less than the skin tone frequency threshold, the at least one processor decreases a first shutter speed of the first camera to a second shutter speed. The at least one processor captures a second image, via the first camera using the second shutter speed.

According to another embodiment, the method includes capturing, via a first camera, a first image. The method includes determining, via at least one processor of an electronic device, if the first image contains a face. In response to determining the first image contains the face, the method includes identifying a skin tone frequency associated with the face based on the first image. The method includes determining if the skin tone frequency is less than a skin tone frequency threshold. In response to determining the skin tone frequency is less than the skin tone frequency threshold, the method includes decreasing a first shutter speed of the first camera to a second shutter speed. The method includes capturing a second image, via the first camera using the second shutter speed.

According to an additional embodiment, a computer program product includes a computer readable storage device having stored thereon program code that, when executed by at least one processor of an electronic device having a first camera, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

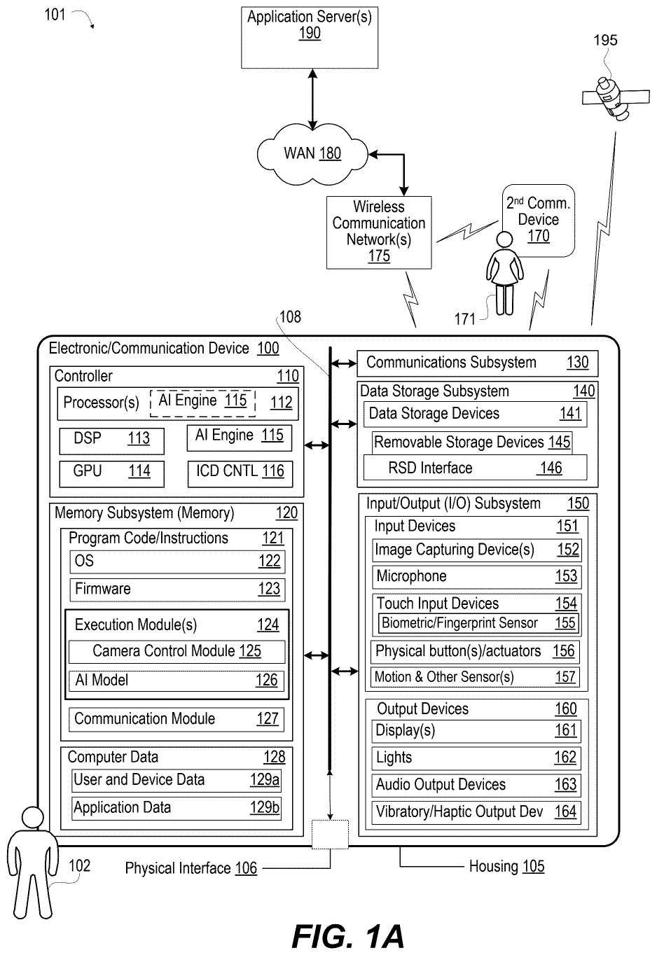

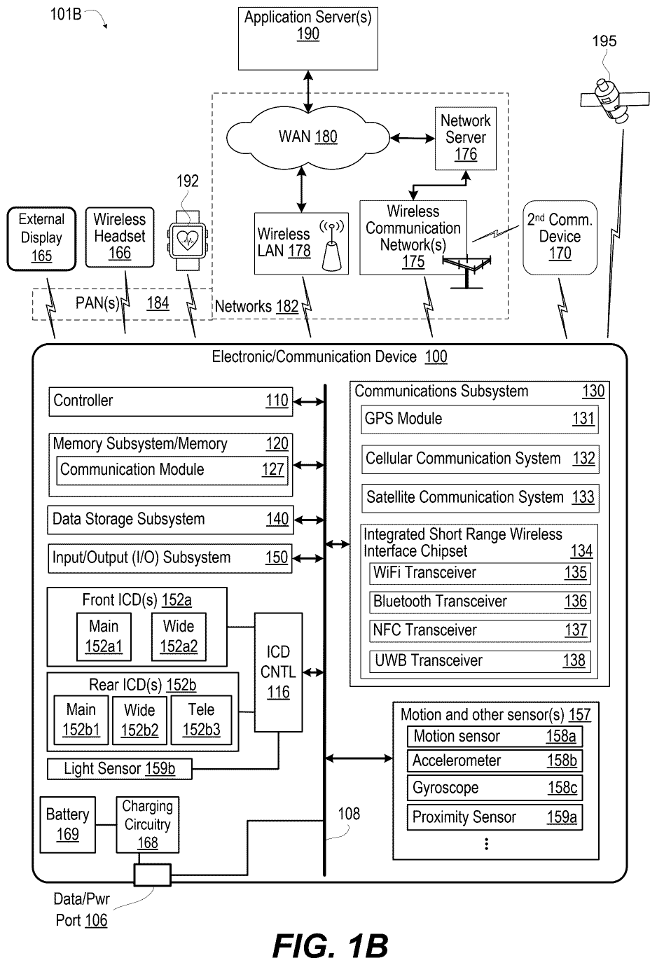

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in a communication environment 101 and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown).

Controller 110 manages, and in some instances directly controls, the various functions and/or operations of communication device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) include instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, camera control module 125, which provides the features and operating functionality of the disclosed embodiments when the corresponding program instructions of camera control module 125 are processed by/within processor 112/controller 110. Specifically, camera control module 125 provides program instructions for controlling image capturing, via a camera, to capture facial images with sufficient clarity or brightness for use in a facial recognition process.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within camera control module 125 and is trained to support the AI features of camera control module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identify the underlying features performed by processing the different modules. For example, camera control module 125 can include program instructions that cause or configure processor 112 to cause electronic device 100 to control image capture of facial images based on skin tone frequency for use in a facial recognition process. Other features provided by camera control module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of communication device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of camera control module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide for multiple integrated displays within electronic device 100 and references to display(s) 161 are assumed to refer to one or all of these multiple integrated displays.

Vibration/haptic output device 164 can cause electronic device 100 to vibrate or shake when activated. Vibration device 164 can be activated during an incoming call or message in order to provide an alert or notification to a user of electronic device 100. Audio output devices (e.g., a speaker) 163 can provide an audio alert or other audio output to a user. In one or more embodiments, integrated display 161, audio output devices (or speakers) 163, and vibration/haptic device 164 can generally and collectively be referred to as output devices.

With reference now to FIG. 1B and with continuing reference to FIG. 1A, there is presented another view of electronic device 100 with additional components, including components enabling electronic device 100 to function as a mobile communication device, within a more comprehensive, expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 is used by a user 171 and can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 190 can enable electronic device 100 to access application servers 190, which can provide a downloadable version of camera control module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B further presents additional details of ICD(s) 152 of electronic device 100. Throughout the disclosure, the term image capturing device (ICD) is utilized interchangeably to be synonymous with and/or refer to any one of the cameras of electronic device 100. ICD(s) 152 includes front camera(s) 152a and rear camera(s) 152b. Each of front ICD(s) 152a and 152b are communicatively coupled to ICD controller 116. ICD controller 116 supports the processing of image data from front cameras 152a and rear cameras 152b. Front ICD(s) 152a can include a main camera 152a1 and a wide angle camera 152a2. Rear ICD(s) 152b can include a main camera 152b1, a wide angle camera 152b2, and a telephoto camera 152b3. Both sets of camera(s) 152 include image sensors that can capture images that are within the field of view (FOV) of each respective camera 152. In one or more embodiments, ICDs can be utilized to enable biometric authentication using facial image or iris scan recognition. Electronic device 100 includes a light sensor 159b that is communicatively coupled to ICD controller 116. Light sensor 159b can sense light intensity values that are a measure of the amount of light reflected from a region of interest.

In the description of each of the following figures, reference is also made to specific components illustrated within the preceding figure(s). Similar or same components are presented with the same leading reference number.

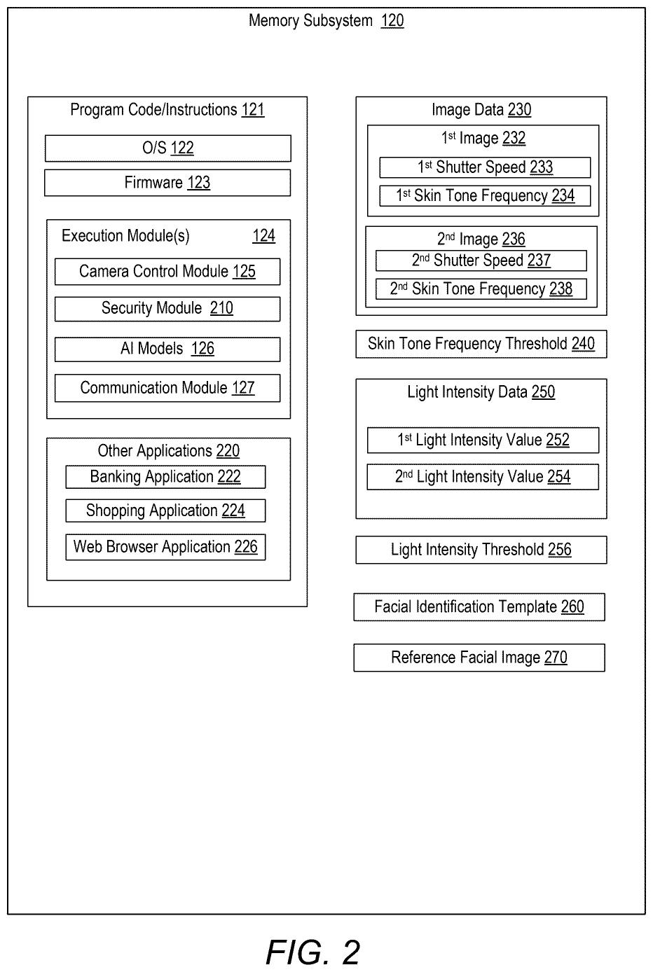

Referring to FIG. 2, there is shown one embodiment of example contents of memory subsystem 120 of electronic device 100 configured to complete the various processes described herein. Memory subsystem 120 includes program code/instructions 121 including data, software, and/or firmware modules, such as OS 122, firmware 123, execution module(s) 124, and applications 220. Execution module(s) 124 include camera control module 125, security module 210, AI models 126, and communication module 127.

Examples of applications 220 include banking application 222, shopping application 224, and web browser application 226. Banking application 222 includes program code that is executed by processor 112 to enable electronic device 100 to access banking services provided by a bank or other financial institution, such as a credit card company, online payment service, etc. Shopping application 224 includes program code that is executed by processor 112 to enable electronic device 100 to access websites to view, browse and buy products or services from a retailer or service provider. Web browser application 226 includes program code that is executed by processor 112 to enable electronic device 100 to access various websites of the Internet. While applications 220 are shown including three applications, applications 220 can include more or fewer than three applications.

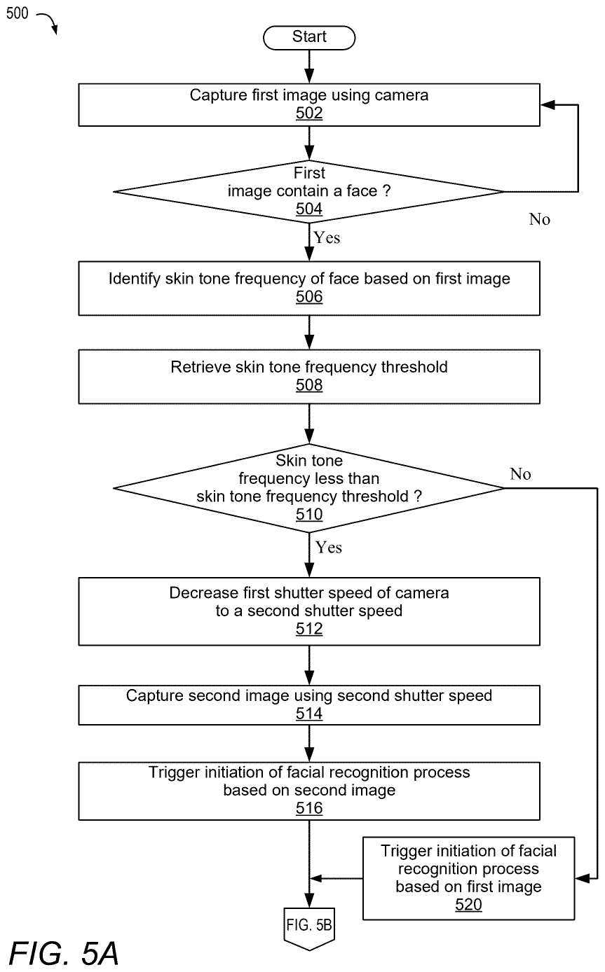

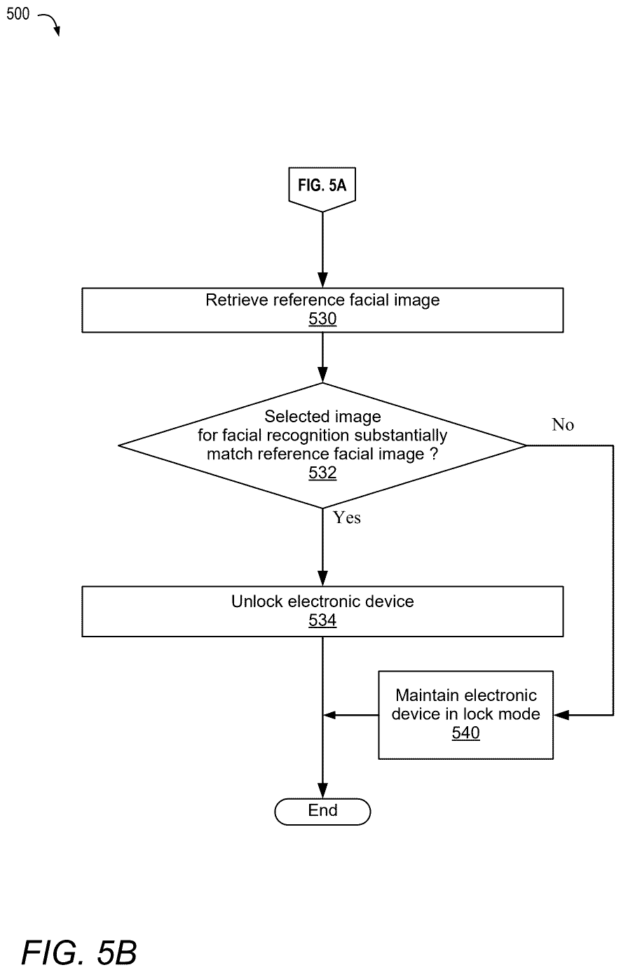

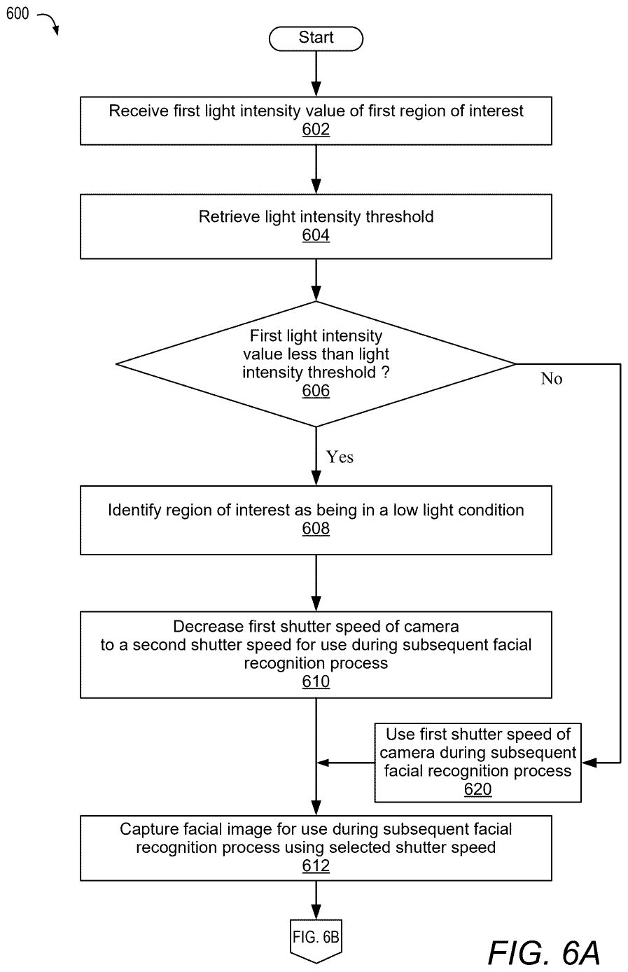

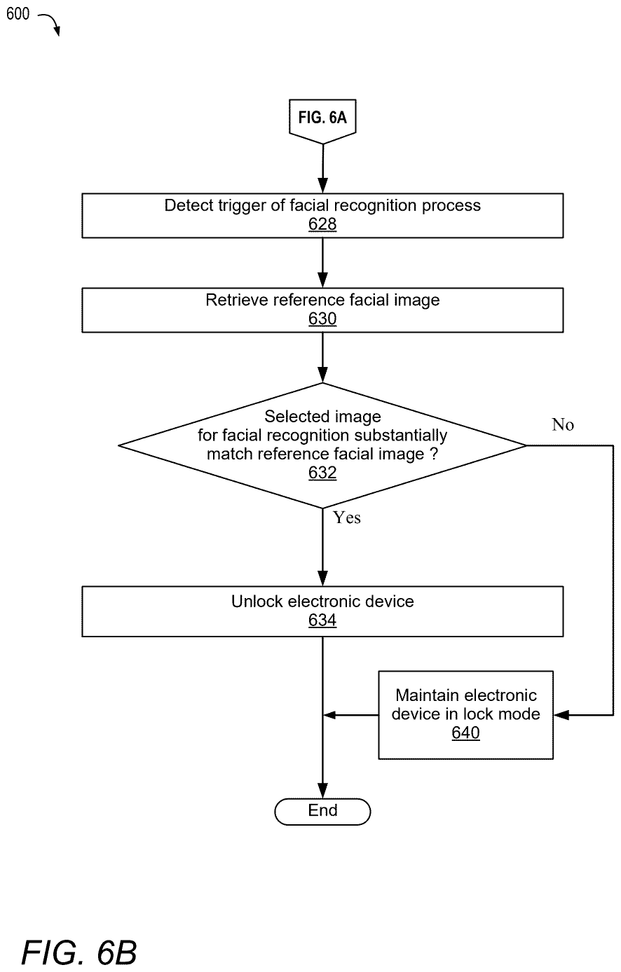

Camera control module 125 includes program code that is executed by processor 112 to enable electronic device 100 to perform the various features of the present disclosure. In one or more embodiments, camera control module 125 enables electronic device 100 and in particular, ICD controller 116, to adjust operating characteristics of cameras 152 and control image capturing via at least one first camera to capture images for use in a facial recognition process. In one or more embodiments, execution of camera control module 125 by processor 112 configures electronic device 100 to perform the processes presented in the flowcharts of FIGS. 5A-5B and 6A-B, as will be described below.

Security module 210 enables electronic device 100 to perform a facial recognition process to authenticate the identity of a user of the electronic device. In one or more embodiments, execution of security module 210 by processor 112 configures electronic device 100 to perform the processes presented in the flowcharts of 5A-5B and 6A-B, as will be described below.

AI models 126 accelerate artificial intelligence, natural language processing (NLP), context evaluation (CE), and machine learning applications. Communication module 127 enables electronic device 100 to communicate and exchange data with other devices and networks.

Memory subsystem 120 includes image data 230 and skin tone frequency threshold 240. Image data 230 can be captured by one or more cameras 152 of electronic device 100. Image data 230 includes first image 232 and second image 236. First image 232 is captured using first shutter speed 233 and first skin tone frequency 234. Second image 236 is captured using second shutter speed 237 and second skin tone frequency 238. First and second shutter speeds 233 and 237 respectively represent the length of time that an image sensor inside the ICD or camera is exposed to light, when the camera's shutter is open. Shutter speed can also be referred to as exposure time. The amount of light that reaches the image sensor is proportional to the exposure time. In one example embodiment, a 1/250 of a second shutter speed will let in twice as much light in as a 1/500 of a second shutter speed.

First and second skin tone frequency 234 and 238 respectively represent a measure of the color of the face of a user in first image 232. In one embodiment, each of first and second skin tone frequency 234, 238 can include values for hue, saturation and brightness. Hue is the dominant color wavelength of the visible spectrum. Saturation is the amount of white light that is mixed with a hue. Brightness refers to the intensity in the image and is characterized by the amount of shading mixed with the hue.

Skin tone frequency threshold 240 is a pre-determined minimum value of skin tone frequency that ensures that an image captured for completion of a facial recognition processes will have sufficient brightness to accurately complete the facial recognition process. The facial recognition process can be completed when the skin tone frequency of a captured image is (at least equal to or) greater than the skin tone frequency threshold 240. One or more embodiments can involve use of the Fitzpatrick scale in determining a relative skin tone frequency of a face captured in an image. Other methodologies for making the determination are also contemplated and implemented within alternate embodiments of the disclosure. The disclosure contemplates embodiments that use known skin color characteristics in determining the skin tone frequency, in part based on an amount of ambient light or other light source reflecting off the face of the user.

Memory subsystem 120 includes light intensity data 250 and light intensity threshold 256. Light intensity data 250 includes first light intensity value 252 and second light intensity value 254. First and second light intensity values 252 and 254 are measured by light sensor 196 and are a measure of the amount of light reflected from a region of interest. In one embodiment, front cameras 152a and rear cameras 152b can include an internal light sensor that can provide light intensity values. Light intensity threshold 256 is a pre-determined minimum value of light intensity value that ensures that an image captured for completion of a facial recognition processes will have sufficient brightness to accurately complete the facial recognition process.

Memory subsystem 120 includes facial identification template 260 and reference facial image 270. Facial identification template 260 is a reference pattern or map of facial features of a registered or authenticated user of electronic device 100 that is stored during a facial enrollment process. Reference facial image 270 is a facial image of a registered or authenticated user of electronic device 100 that is stored during a facial enrollment process. In one embodiment, facial identification template 260 and reference facial image 270 are at least partially based on an image captured using the second shutter speed 237 that provides an increased image brightness that is sufficiently bright to accurately complete the facial recognition process.

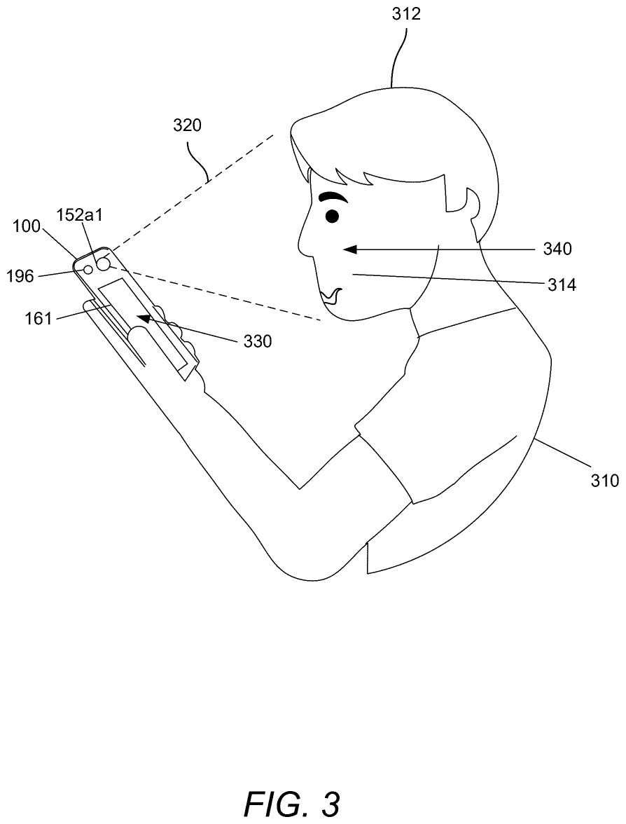

FIG. 3 illustrates an example of a user 310 attempting to unlock electronic device 100 using facial recognition, when the electronic device is in a lock mode, presenting a lock screen 330. In lock mode, only a limited number of features or functions of electronic device 100 are accessible by a user. Head 312 and face 314 of user 310 is shown within a field of view 320 of front camera 152a1. The user 310 can look at or view lock screen 330 presented on display 161 of electronic device 100. In one embodiment, electronic device 100 can operate in an always on video mode and/or periodically capture images using front camera 152a1, including the face 314 of user 310 when the face 314 of the user 310 is within field of view 320. The captured image(s) is/are then used in a subsequent facial recognition process, as will be described below.

Light sensor 196 can measure light intensity values such as first light intensity value 252 of a first region of interest (ROI) 340. The first ROI 340 corresponds to an area including at least a portion of the face 314 of user 310. Light sensor 196 can measure the amount of light reflected from the ROI 340. In one embodiment, light sensor 196 can provide light intensity values in units of lux (lumens per square meter).

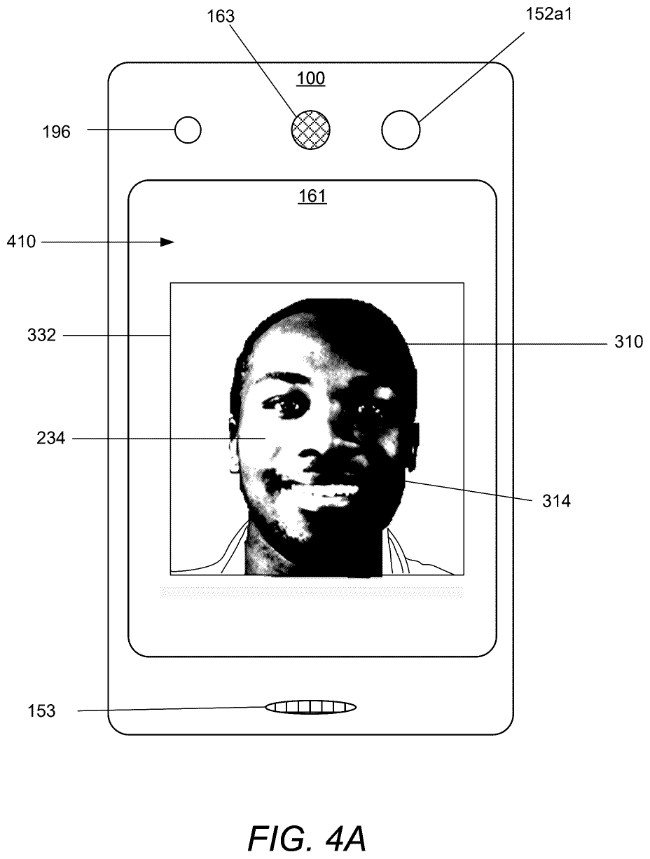

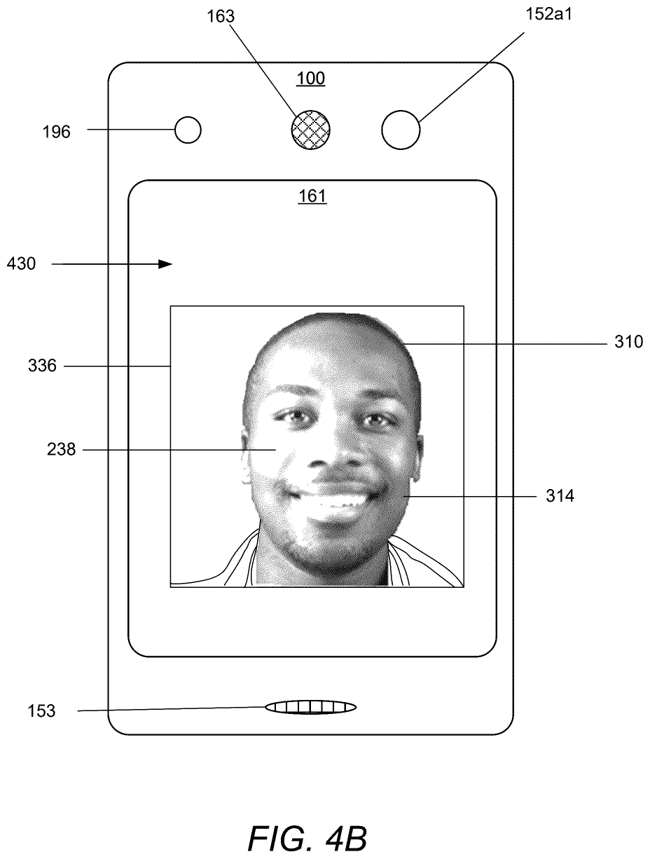

With reference to FIG. 4A, electronic device 100 is shown with an example graphical user interface (GUI) 410 on display 161 presenting captured facial image 332 (i.e., corresponds to stored first image 232 of image data 230) of a user having a dark skin tone. In the illustration of FIG. 4A, the electronic device 100 is being operated in an environment having a low light condition. Captured facial image 332 contains the face 314 of user 310 and was captured using front camera 152a1 operating with first shutter speed 233. As utilized herein, shutter speed or exposure time is the length of time that an image sensor inside the ICD or camera is exposed to light, when the camera's shutter is open. The amount of light that reaches the image sensor is proportional to the exposure time. First shutter speed 233 is assumed to be a first value X, which can be measured in milliseconds, hundredths of a second, or other measurable time quantity.

Facial image 332 also has an associated first skin tone frequency 234. In one embodiment, camera 152a1 and/or ICD controller 116 can determine first skin tone frequency 234 based on first image 232. In one or more embodiments, after capturing the first image, camera 152a1 and/or ICD controller 116 can process the first image 232 using software to analyze and determine first skin tone frequency 234 of an individual in the image. First skin tone frequency 234 has a low brightness (i.e., darker) because of the first shutter speed used during image capture. In an embodiment, when first image 232 is used in a facial recognition process, the result of the facial recognition process can be a false rejection because the image does not have sufficient brightness to accurately complete the facial recognition process.

With reference to FIG. 4B, electronic device 100 is shown with a second example graphical user interface (GUI) 430 presented on display 161 presenting captured facial image 336 (i.e., corresponds to stored second image 236 of image data 230) of a user having a dark skin tone. In the illustration of FIG. 4B, the electronic device 100 is being operated in an environment having a low light condition. Captured facial image 336 contains the face 314 of user 310 and was captured using front camera 152a1 operating with second shutter speed 237. The second shutter speed 237 is lower or less than the first shutter speed 233 such that front camera 152a1 can collect more light during image capture, resulting in a brighter image.

Facial image 336 also has an associated second skin tone frequency 238. In one embodiment, camera 152a1 and/or ICD controller 116 can determine second skin tone frequency 238 based on second image 236. Second skin tone frequency 238 has an increased brightness compared to skin tone frequency 234 because of the use of the lower second shutter speed during image capture. In an embodiment, when second image 236 is used in a facial recognition process, the result of the facial recognition process can be a correct authentication of the user because the image has sufficient brightness to accurately complete the facial recognition process. In one embodiment, a facial recognition algorithm can identify facial features by extracting landmarks, features, or markers from an image of the subject's face. The identified facial features are then compared and/or matched to the facial features of a reference image. For example, an algorithm may analyze the relative position, size, and/or shape of the eyes, nose, cheekbones, and jaw. A brighter image captured using a lower shutter speed can have more readily discernible landmarks, features or markers as compared to a darker image.

According to one aspect of the disclosure, electronic device 100 can capture first image 232 via front camera 152a1. Electronic device 100 determines if the first image 232 contains a face. In response to determining the first image contains the face, electronic device 100 identifies a first skin tone frequency 234 associated with the face based on the first image 232. Electronic device 100 determines if the first skin tone frequency 234 is less than a skin tone frequency threshold 240. In response to determining the first skin tone frequency 234 is less than the skin tone frequency threshold 240, electronic device 100 decreases a first shutter speed 233 of front camera 152a1 to a second shutter speed 237. Electronic device 100 captures a second image 236, via camera 152a1 using the second shutter speed 237.

According to another aspect of the disclosure, electronic device 100 can receive a first light intensity value 252 of a first region of interest (ROI) 340 from light sensor 196. Electronic device 100 retrieves a light intensity threshold 256 and determines if the first light intensity value 252 is less than the light intensity threshold 256. In response to determining the first light intensity value 252 is less than the light intensity threshold 256, electronic device 100 identifies the ROI 340 as being in a low light intensity condition. In response to identifying the ROI 340 as being in a low light intensity condition, electronic device 100 triggers a decrease in shutter speed of camera 152a1 during a subsequent facial recognition process.

According to an additional aspect of the disclosure, in response to determining the first skin tone frequency 234 is not less than the skin tone frequency threshold 240, electronic device 100 identifies the first image 232 to be used in a facial recognition processes to authenticate the identity of a user 310.

According to one more aspect of the disclosure, electronic device 100 can trigger a facial recognition process to authenticate the identity of user 310. The facial recognition process is at least partially based on the second image 236 captured using the second shutter speed 237.

According to yet another aspect of the disclosure, capturing the first image 232 is triggered by initiation of a facial recognition process to authenticate the identity of a user 310.

According to one more additional aspect of the disclosure, electronic device 100 can trigger a facial enrollment process to establish a facial identification template 260. The facial identification template 260 is at least partially based on the second image 236 captured using the second shutter speed 237.

According to a further aspect of the disclosure, electronic device 100 can include a memory subsystem 120 that stores security module 210 for authenticating the identity of a user of the electronic device. Electronic device 100 retrieves a reference facial image 270 and determines if the second image 236 substantially matches the reference facial image 270. In response to the second image 236 substantially matching the reference facial image 270, processor 112 of electronic device 100 unlocks the electronic device.

FIGS. 5A-5B depicts method 500 by which electronic device 100 controls image capture based on skin tone frequency to capture images for use in a facial recognition process. FIGS. 6A-6B depicts method 600 by which electronic device 100 controls image capture based on light intensity values for use in a facial recognition process.

The description of methods 500 and 600 will be described with reference to the components and examples of FIGS. 1-4B. The operations depicted in FIGS. 5A-5B and 6A-6B can be performed by electronic device 100 or any suitable electronic device that includes the one or more operational components of electronic device 100 that provide/enable the described features. One or more of the processes of the methods described in FIGS. 5A-B and 6A-6B may be performed by processor 112 executing program code associated with camera control module 125 and security module 210.

With specific reference to FIG. 5A, method 500 begins at the start block. At block 502, method 500 includes capturing first image 232 using front camera 152a1. Method 500 includes determining if the first image 232 contains a face (e.g., face 314) (decision block 504). In response to determining the first image 232 does not contain a face, method 500 continues to capture another image using front camera 152a1 (block 502) and determine if the image contains a face (decision block 504) at a pre-set interval.

In response to determining the first image 232 contains a face, method 500 includes identifying a first skin tone frequency 234 associated with the face 314 based on the first image 232 (block 506). In one or more embodiments, after capturing the first image, camera 152a1 and/or ICD controller 116 can process the first image 232 using software to analyze and determine first skin tone frequency 234 of an individual in the image. Method 500 includes retrieving skin tone frequency threshold 240 from memory subsystem 120 (block 508). Method 500 includes determining if the first skin tone frequency 234 is less than a skin tone frequency threshold 240 (decision block 510). In response to determining the first skin tone frequency 234 is not less than the skin tone frequency threshold 240, method 500 includes triggering a facial recognition process to authenticate the identity of a user based on the first image 232 (block 520). Method 500 then continues at block 530 (FIG. 5B).

In response to determining the first skin tone frequency 234 is less than the skin tone frequency threshold 240, method 500 includes decreasing a first shutter speed 233 of front camera 152a1 to a second shutter speed 237 (block 512). Method 500 includes capturing a second image 236, via camera 152a1 using the second shutter speed 237 (block 514). Method 500 includes triggering a facial recognition process to authenticate the identity of a user based on the second image 232 (block 516). Method 500 then continues at block 530 (FIG. 5B).

With reference to FIG. 5B, method 500 includes retrieving a reference facial image 270 (e.g., the authenticated facial image of a registered user of the electronic device) (block 530) and determining if the selected image for the facial recognition process (e.g., one of first image 232 or second image 236) substantially matches the reference facial image 270 (decision block 532).

In response to the selected image not substantially matching the reference facial image 270, method 500 includes maintaining the electronic device in lock mode 330 (block 540). Method 500 then ends at the end block. In response to the selected image substantially matching the reference facial image 270, method 500 includes unlocking the electronic device (i.e., transitioning the electronic device to an unlocked mode) (block 534). Method 500 terminates at the end block.

FIG. 6A-6B depict method 600 by which electronic device 100 controls image capture based on light intensity values for use in a facial recognition process. With specific reference to FIG. 6A, method 600 begins at the start block. At block 602, method 600 includes receiving a first light intensity value 252 of a first region of interest (ROI) 340 from light sensor 196. Method 600 includes retrieving light intensity threshold 256 (block 604) and determining if the first light intensity value 252 is less than the light intensity threshold 256 (decision block 606). In response to determining the first light intensity value 252 is not less than the light intensity threshold 256, method 600 includes using the current shutter speed of front camera 152a1 (e.g., first shutter speed 233) to capture a facial image during a subsequent facial recognition process (block 620). Method 600 then continues at block 628 (FIG. 6B).

In response to determining the first light intensity value 252 is less than the light intensity threshold 256, method 600 includes identifying the ROI 340 as being in a low light intensity condition (block 608). In response to identifying the ROI 340 as being in a low light intensity condition, method 600 includes triggering a decrease in the shutter speed of front camera 152a1 from a first shutter speed 233 to a second shutter speed 237 (block 610) and capturing a facial image for use during a subsequent facial recognition process using the selected shutter speed (block 612). Method 600 then continues at block 628 (FIG. 6B).

With reference to FIG. 6B, method 600 includes detecting a trigger to initiate a facial recognition process (block 628) and retrieving a reference facial image 270 (e.g., the authenticated facial image of a registered user of the electronic device) (block 630). Method 600 includes determining if the selected image for the facial recognition process (e.g., one of first image 232 or second image 236 captured using the selected shutter speed) substantially matches the reference facial image 270 (decision block 632).

In response to the selected image not substantially matching the reference facial image 270, method 600 includes maintaining the electronic device in lock mode 330 (block 640). Method 600 then ends at the end block. In response to the selected image substantially matching the reference facial image 270, method 600 includes unlocking the electronic device (i.e., transitioning the electronic device to an unlocked mode) (block 634). Method 600 terminates at the end block.

The disclosure enables an electronic device to control image capture, based on skin tone frequency and ambient or impinging light intensity, to capture images for use in a facial recognition process. The disclosure enables an electronic device to identify a skin tone frequency of a facial image. The disclosure enables an electronic device to determine that a skin tone frequency of the facial image is inadequate to accurately complete a facial recognition process and to decrease a shutter speed of a camera to capture a subsequent facial image with sufficient brightness to accurately complete the facial recognition process. The disclosure enables an improved face recognition process by reducing the number of false rejections during the facial recognition process.

In the above-described methods of FIGS. 5A-6B, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a first camera;
a memory having stored thereon a camera control module for controlling image capturing via the first camera; and
at least one processor communicatively coupled to each of the first camera and the memory, and which executes program code of the camera control module, the at least one processor configured to cause the electronic device to:
capture, via the first camera, a first image;
determine if the first image contains a face;
in response to determining the first image contains the face, identify a skin tone frequency associated with the face based on the first image;
determine if the skin tone frequency is less than a skin tone frequency threshold;
in response to determining the skin tone frequency is less than the skin tone frequency threshold, decrease a first shutter speed of the first camera to a second shutter speed; and
capture a second image, via the first camera using the second shutter speed.

2. The electronic device of claim 1, wherein in response to determining the skin tone frequency is not less than the skin tone frequency threshold, identify the first image to be used in a facial recognition processes to authenticate the identity of a first user.

3. The electronic device of claim 1, wherein the at least one processor is configured to cause the electronic device to:
trigger a facial recognition process to authenticate the identity of a first user, the facial recognition process at least partially based on the second image captured using the second shutter speed.

4. The electronic device of claim 1, wherein capturing the first image is triggered by initiation of a facial recognition process to authenticate the identity of a first user.

5. The electronic device of claim 1, further comprising:
at least one light sensor that is communicatively coupled to the at least one processor, and wherein the at least one processor is configured to cause the electronic device to:
receive a first light intensity value of a first region of interest from the at least one light sensor;
retrieve a light intensity threshold;
determine if the first light intensity value is less than the light intensity threshold;
in response to determining the first light intensity value is less than the light intensity threshold, identify the region of interest as being in a low light intensity condition; and
in response to identifying the region of interest as being in a low light intensity condition, trigger a decrease in shutter speed of the first camera during a subsequent facial recognition process.

6. The electronic device of claim 1, wherein the at least one processor is configured to cause the electronic device to:
trigger a facial enrollment process to establish a facial identification template, the facial identification template at least partially based on the second image captured using the second shutter speed.

7. The electronic device of claim 1, wherein the memory has stored thereon a security module for authenticating the identity of a user of the electronic device, and the at least one processor is configured to cause the electronic device to:
retrieve a reference facial image;
determine if the second image substantially matches the reference facial image; and
in response to the second image substantially matching the reference facial image, unlocking the electronic device.

8. A method comprising:
capturing, via a first camera, a first image;
determining, via at least one processor of an electronic device, if the first image contains a face;
in response to determining the first image contains the face, identifying a skin tone frequency associated with the face based on the first image;
determining if the skin tone frequency is less than a skin tone frequency threshold;
in response to determining the skin tone frequency is less than the skin tone frequency threshold, decreasing a first shutter speed of the first camera to a second shutter speed; and
capturing a second image, via the first camera using the second shutter speed.

9. The method of claim 8, further comprising:
in response to determining the skin tone frequency is not less than the skin tone frequency threshold, identifying the first image to be used in a facial recognition processes to authenticate the identity of a first user.

10. The method of claim 8, further comprising:
triggering a facial recognition process to authenticate the identity of a first user, the facial recognition process at least partially based on the second image captured using the second shutter speed.

11. The method of claim 8, wherein capturing the first image is triggered by initiation of a facial recognition process to authenticate the identity of a first user.

12. The method of claim 8, further comprising:
receiving a first light intensity value of a first region of interest from at least one light sensor;
retrieving a light intensity threshold;
determining if the first light intensity value is less than the light intensity threshold;
in response to determining the first light intensity value is less than the light intensity threshold, identifying the region of interest as being in a low light intensity condition; and
in response to identifying the region of interest as being in a low light intensity condition, triggering a decrease in shutter speed of the first camera during a subsequent facial recognition process.

13. The method of claim 8, further comprising:
triggering a facial enrollment process to establish a facial identification template, the facial identification template at least partially based on the second image captured using the second shutter speed.

14. The method of claim 8, further comprising:
retrieving a reference facial image;
determining if the second image substantially matches the reference facial image; and
in response to the second image substantially matching the reference facial image, unlocking the electronic device.

15. A computer program product comprising:
a computer readable storage device having stored thereon program code which, when executed by at least one processor of an electronic device having a first camera, configures the electronic device to complete the functionality of:
capturing, via the first camera, a first image;
determining if the first image contains a face;
in response to determining the first image contains the face, identifying a skin tone frequency associated with the face based on the first image;
determining if the skin tone frequency is less than a skin tone frequency threshold;
in response to determining the skin tone frequency is less than the skin tone frequency threshold, decreasing a first shutter speed of the first camera to a second shutter speed; and
capturing a second image, via the first camera using the second shutter speed.

16. The computer program product of claim 15, wherein the program code further configures the electronic device to complete the functionality of:
in response to determining the skin tone frequency is not less than the skin tone frequency threshold, identifying the first image to be used in a facial recognition processes to authenticate the identity of a first user.

17. The computer program product of claim 15, wherein the program code further configures the electronic device to complete the functionality of:
triggering a facial recognition process to authenticate the identity of a first user, the facial recognition process at least partially based on the second image captured using the second shutter speed.

18. The computer program product of claim 15, wherein capturing the first image is triggered by initiation of a facial recognition process to authenticate the identity of a first user.

19. The computer program product of claim 15, wherein the program code further configures the electronic device to complete the functionality of:
receiving a first light intensity value of a first region of interest from at least one light sensor;
retrieving a light intensity threshold;
determining if the first light intensity value is less than the light intensity threshold;
in response to determining the first light intensity value is less than the light intensity threshold, identifying the region of interest as being in a low light intensity condition; and
in response to identifying the region of interest as being in a low light intensity condition, triggering a decrease in shutter speed of the first camera during a subsequent facial recognition process.

20. The computer program product of claim 15, wherein the program code further configures the electronic device to complete the functionality of:
triggering a facial enrollment process to establish a facial identification template, the facial identification template at least partially based on the second image captured using the second shutter speed.
